(19) United States
(12) Patent Application Publication
(10) Pub. No.: US 2003/0022050 A1
(43) Pub. Date: Jan. 30, 2003

(54) Product water pump for fuel cell system

(75) Inventors: Russell Howard Barton, New Westminster (CA); Tan Duc Uong, Coquitlam (CA)

Correspondence Address: SEED INTELLECTUAL PROPERTY LAW GROUP PLLC, 701 FIFTH AVE, SUITE 6300, SEATTLE, WA, 98104-7092, US

(73) Assignee: Ballard Power Systems Inc., Burnaby, BC (CA)

(21) Appl. No.: 09/916,118

(22) Filed: Jul. 25, 2001

(51) Int. Cl. H01M 8/04; H01M 8/10

(52) U.S. Cl. 429/34; 429/25; 429/30

(57) ABSTRACT

An electric power generation system includes a fuel cell stack and a product water pumping system from the stack to pump product water away from the power generation system. A reactant exhaust chamber is coupled to a product water pumping chamber by a drain, and a valve controls the flow of water through the drain. An oxidant exhaust inlet provides an oxidant exhaust flow to the reactant exhaust chamber from the stack, while an oxidant exhaust outlet discharges oxidant exhaust from the reactant exhaust chamber. A pump fluid inlet provides a pump fluid flow to product water pumping chamber from the stack to pump collected product water out of the product water pumping chamber via a product water outlet. The pump fluid flow can take the form of a fuel stream or by a purge discharge containing fuel.

### BACKGROUND OF THE INVENTION

1. Technical Field

The present invention relates to fuel cells, and particularly to a system for pumping product water away from a fuel cell system during fuel cell operation.

2. Description of the Related Art

Electrochemical fuel cells convert fuel and oxidant to electricity. Solid polymer electrochemical fuel cells generally employ a membrane electrode assembly (“MEA”) which comprises an ion exchange membrane or solid polymer electrolyte disposed between two electrodes typically comprising a layer of porous, electrically conductive sheet material, such as carbon fiber paper or carbon cloth. The MEA contains a layer of catalyst, typically in the form of finely comminuted platinum, at each membrane/electrode interface to induce the desired electrochemical reaction. In operation the electrodes are electrically coupled to provide a circuit for conducting electrons between the electrodes through an external circuit. Typically, a number of MEAs are serially coupled electrically to form a fuel cell stack having a desired power output.

In typical fuel cells, the MEA is disposed between two electrically conductive fluid flow field plates or separator plates. Fluid flow field plates have at least one flow passage formed in at least one of the major planar surfaces thereof. The flow passages direct the fuel and oxidant to the respective electrodes, namely, the anode on the fuel side and the cathode on the oxidant side. The fluid flow field plates act as current collectors, provide support for the electrodes, provide access channels for the fuel and oxidant to the respective anode and cathode surfaces, and provide channels for the removal of reaction products, such as water, formed during operation of the cell.

In certain fuel cell systems, product water is removed from time to time. For example, in stationary fuel cell applications, a knockout tank may be provided to collect product water exhausted from the fuel cell stack. After a certain amount of product water has been collected, a valve may be opened to allow water to be drained by gravity out of the collector tank. Noises such as gurgling sometime accompany such drainage, especially when water is drained intermittently. Such noise is typically unwanted when the fuel cell system is operated in close proximity to human activity, such as inside a home, or in a motor vehicle. Such noises may be reduced by using electric pumps to pump the product water away from the fuel cell system; such pumps also are useful to transport the water further away than possible by gravity-based drainage. However, such pumps impose an additional parasitic load on the fuel cell system, thereby reducing the net power output of the fuel cell system, and add system complexity and cost to the fuel cell system.

### SUMMARY OF THE INVENTION

According to one aspect of the invention, there is provided an electric power generation system comprising a fuel cell stack, reactant flow paths to and from the stack, and a product water pumping system comprising a product water collector for collecting product water separated from a reactant exhaust stream from the stack, a pump fluid inlet on the collector and fluidly connected to a reactant flow path, and a product water outlet on the collector, wherein collected product water is pumped out of the collector by a flow of reactant into the collector via the pump fluid inlet.

The fuel cell stack comprises at least one solid polymer fuel cell. The reactant flow paths include a fuel flow path to and from the stack and an oxidant flow path to and from the stack.

The product water collector may further comprise a product water pumping chamber for collecting the product water. The product water pumping chamber may comprise a drain for receiving the product water. A one-way valve controls the flow of product water through the drain to the product water pumping chamber. The product water pumping chamber may also comprise a pump fluid inlet which may be coupled to one of the reactant flow paths from the stack, typically the fuel flow path. The fuel flow path from the stack transmits a fuel exhaust stream typically composed of unreacted hydrogen fuel, impurities in the fuel supply stream and other non-reactive components such as nitrogen. The stack may operate in a dead-ended mode, in which a purge valve in the fuel flow path from the stack is openable from time to time to discharge the fuel exhaust stream (otherwise referred to as “purge discharge”).

The product water collector may further comprise a reactant exhaust chamber for separating product water from a reactant stream, such as an oxidant exhaust stream flowing therethrough. The reactant exhaust chamber may comprise an oxidant inlet connected to the oxidant flow path from the stack, and an outlet for discharging the oxidant exhaust stream from the reactant exhaust chamber.

The reactant exhaust chamber and the product water pumping chamber may be combined in a single product water containment tank. The tank may comprise a partition that, when the valve is closed, separates the reactant exhaust chamber from the product water pumping chamber. The drain may be located in the partition. The partition may also comprise a pressure equalization port for equalizing the pressure between the reactant exhaust chamber and the product water pumping chamber.

According to another aspect of the invention, in the electric power generation system described above, the fuel flow path from the stack is connected to the pump fluid inlet in a product water pumping chamber, and to an inlet in the reactant exhaust chamber. A purge valve may be provided in the fuel flow path which is operable to selectively direct a purge discharge from the stack to the reactant exhaust chamber, or to direct the purge discharge from the stack to the product water chamber. In particular, a first fuel flow path may be provided between the stack and the reactant exhaust chamber, and a second fuel flow path may be provided between the stack and the product water chamber. The purge valve may be located in the first fuel flow path and may be closed so that the purge discharge is directed to the product water chamber via the second fuel flow path, and may be opened so that the purge discharge is directed to the reactant exhaust chamber.

The product water pumping chamber may further comprise a flexible fluid impermeable diaphragm that provides a fluid seal between a portion of the pumping chamber having the pump fluid inlet, and a portion of the pumping chamber having the drain and the product water outlet, such that a displacement of the diaphragm by a flow of purge discharge into the product water pumping chamber pumps product water from the pumping chamber through the product water outlet.

According to yet another aspect of the invention, there is provided a product water pumping system comprising a product water collector for collecting product water separated from a reactant flow from a fuel cell stack in an electric power generation system, a pump fluid inlet on the collector and fluidly connected to a reactant flow path associated with the fuel cell stack, and a product water outlet on the collector, wherein collected product water is pumped out of the collector by a flow of reactant through the pump fluid inlet into the collector.

The collector may comprise a reactant exhaust chamber, a product water pumping chamber, a drain fluidly connecting the reactant exhaust chamber to the product water pumping chamber, and a one-way valve in the drain for controlling the flow of product water from the reactant exhaust chamber to the product water pumping chamber. The reactant exhaust chamber may further comprise an oxidant inlet connected to the oxidant flow path from the stack, and an outlet for discharging the oxidant from the reactant exhaust chamber. The product water pumping chamber may further comprise the pump fluid inlet connected to the fuel flow path from the stack, and a product water outlet, wherein product water collected in the product water pumping chamber is pumped through the outlet by a purge discharge flowing into the product water pumping chamber via the pump fluid inlet.

According to yet another aspect of the invention, there is provided a method of pumping product water out of a fuel cell system. The method comprises separating product water from a reactant, preferably oxidant, exhaust stream from a fuel cell stack of the fuel cell system, collecting the separated product water, discharging the reactant exhaust stream from the fuel cell system, and using a reactant stream associated with the stack to pump the collected product water out of the fuel cell system. The reactant stream used to pump product water may be a fuel exhaust stream from the stack. The fuel exhaust stream may be discharged from the fuel cell system along with the product water, or may be used to move a flexible fluid impermeable diaphragm that in turn pumps water out of the fuel cell system.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, have been selected solely for ease of recognition in the drawings.

FIG. 1 is an isometric, partially exploded, view of a fuel cell system including a fuel cell stack and controlling electronics including a fuel cell ambient environment monitoring and control system.

FIG. 2 is a schematic diagram representing fuel flow through a cascaded fuel cell stack of the fuel cell system of FIG. 1.

FIG. 3 is a schematic diagram of the fuel cell system as partially illustrated in FIG. 1.

FIG. 4 is a schematic diagram of an additional portion of the fuel cell ambient environment monitoring and control system of FIG. 3, including a fuel cell microcontroller selectively coupled between the fuel cell stack and a battery.

FIG. 5 is a top, right isometric view of a structural arrangement of various components of the fuel cell system of FIG. 1.

FIG. 6 is a top, right isometric view of the structural arrangement of various components of the fuel cell system of FIG. 5 with a cover removed and with a mounting bracket shown in hidden line.

FIG. 7 is top, left isometric view of the structural arrangement of various components of the fuel cell system of FIG. 5.

FIG. 8 is a top, right isometric exploded view of a fuel regulating portion of the fuel cell system of FIG. 5.

FIG. 9 is a side cross-sectional view of a product water containment tank in a product water pumping system of the fuel cell system taken along section line 9-9 of FIG. 1.

FIG. 10 is a top plan view of a partition for the product water containment tank illustrated in FIG. 9.

FIG. 11 is a schematic diagram of a product water pumping system according to an alternative embodiment of the invention.

FIG. 12 is a schematic diagram of a fuel cell system having a product water pumping system according to an alternative embodiment of the invention.

### DETAILED DESCRIPTION OF PREFERRED EMBODIMENTS

In the following description, certain specific details are set forth in order to provide a thorough understanding of various embodiments of the invention. However, one skilled in the art will understand that the invention may be practiced without these details. In other instances, well known structures associated with fuel cells, microcontrollers, sensors, and actuators have not been described in detail to avoid unnecessarily obscuring the descriptions of the embodiments of the invention.

Unless the context requires otherwise, throughout the specification and claims which follow, the word “comprise” and variations thereof, such as “comprises” and “comprising” are to be construed in an open, inclusive sense, that is as “including but not limited to.”

Fuel Cell System Overview

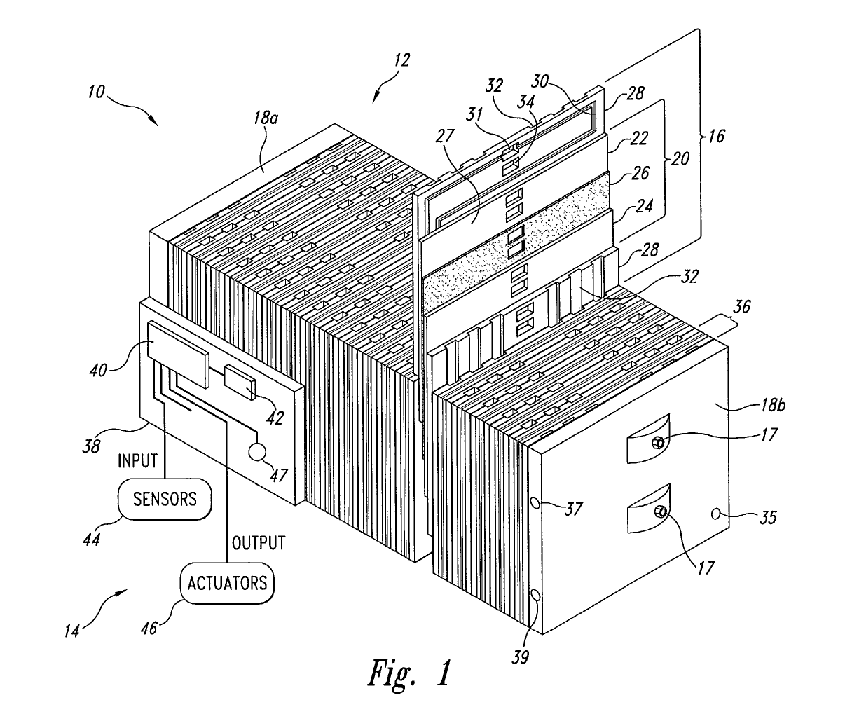

FIG. 1 shows a portion of a fuel cell system 10, namely, a fuel cell stack 12 and an electronic fuel cell monitoring and control system 14. Fuel cell stack 12 includes a number of fuel cell assemblies 16 arranged between a pair of end plates 18a, 18b, one of the fuel cell assemblies 16 being partially removed from fuel cell stack 12 to better illustrate the structure of fuel cell assembly 16. Tie rods (not shown) extend between end plates 18a, 18b and cooperate with fastening nuts 17 to bias end plates 18a, 18b together by applying pressure to the various components to ensure good contact therebetween.

Each fuel cell assembly 16 includes a membrane electrode assembly 20 including two electrodes, the anode 22 and the cathode 24, separated by an ion exchange membrane 26. Electrodes 22, 24 can be formed from a porous, electrically conductive sheet material, such as carbon fiber paper or cloth, that is permeable to the reactants. Each of electrodes 22, 24 is coated on a surface adjacent the ion exchange membrane 26 with a catalyst 27, such as a thin layer of platinum, to render each electrode electrochemically active.

The fuel cell assembly 16 also includes a pair of separators or flow field plates 28 sandwiching membrane electrode assembly 20. In the illustrated embodiment, each of the flow field plates 28 includes one or more reactant channels 30 formed on a planar surface of flow field plate 28 adjacent an associated one of the electrodes 22, 24 for carrying fuel to anode 22 and oxidant to cathode 24, respectively. (Reactant channel 30 on only one of flow field plates 28 is visible in FIG. 1.) The reactant channels 30 that carry the oxidant also carry exhaust air and product water away from cathode 24. As will be described in more detail below, fuel stack 12 is designed to operate in a dead-ended fuel mode, thus substantially all of the hydrogen fuel supplied to it during operation is consumed, and little if any hydrogen is carried away from the anode by reactant channels 30 in normal operation of system 10. However, embodiments of the present invention can also be applicable to fuel cell systems operating on dilute fuels which are not dead-ended.

In the illustrated embodiment, each flow field plate 28 may include a plurality of cooling channels 32 formed on the planar surface of the flow field plate 28 opposite the planar surface having reactant channel 30. When the stack is assembled, the cooling channels 32 of each adjacent fuel cell assembly 16 cooperate so that closed cooling channels 32 are formed between each membrane electrode assembly 20. The cooling channels 32 transmit cooling air through the fuel stack 12. The cooling channels are preferably straight and parallel to each other, and traverse each plate 28 so that cooling channel inlets and outlets are located at respective edges of plate 28.

While the illustrated embodiment includes two flow field plates 28 in each fuel cell assembly 16, other embodiments can include a single bipolar flow field plate (not shown) between adjacent membrane electrode assemblies 20. In such embodiments, a channel on one side of the bipolar plate carries fuel to the anode of one adjacent membrane electrode assembly 20, while a channel on the other side of the plate carries oxidant to the cathode of another adjacent membrane electrode assembly 20. In such embodiments, additional flow field plates 28 having channels for carrying coolant (e.g., liquid or gas, such as cooling air) can be spaced throughout fuel cell stack 12, as needed to provide sufficient cooling of stack 12.

End plate 18a includes a fuel stream inlet port (not shown) for introducing a supply fuel stream into fuel cell stack 12. End plate 18b includes a fuel stream outlet port 35 for discharging an exhaust fuel stream from fuel cell stack 12 that comprises primarily water and non-reactive components and impurities, such as any introduced in the supply fuel stream or entering the fuel stream in stack 12. Fuel stream outlet port 35 is normally closed with a valve in dead-ended operation. Although fuel cell stack 12 is designed to consume substantially all of the hydrogen fuel supplied to it during operation, traces of unreacted hydrogen may also be discharged through the fuel stream outlet port 35 during a purge of fuel cell stack 12, effected by temporarily opening a valve at fuel stream outlet port 35. Each fuel cell assembly 16 has openings formed therein to cooperate with corresponding openings in adjacent assemblies 16 to form internal fuel supply and exhaust manifolds (not shown) that extend the length of stack 12. The fuel stream inlet port is fluidly connected to fluid outlet port 35 via respective reactant channels 30 that are in fluid communication with the fuel supply and exhaust manifolds, respectively.

The end plate 18b includes an oxidant stream inlet port 37 for introducing supply air (oxidant stream) into fuel cell stack 12, and an oxidant stream outlet port 39 for discharging exhaust air from fuel cell stack 12. Each fuel cell assembly 16 has openings 31, 34, formed therein to cooperate with corresponding openings in adjacent fuel cell assemblies 16 to form oxidant supply and exhaust manifolds that extend the length of stack 12. The oxidant inlet port 37 is fluidly connected to the oxidant outlet port 39 via respective reactant channels 30 that are in fluid communication with oxidant supply and exhaust manifolds, respectively.

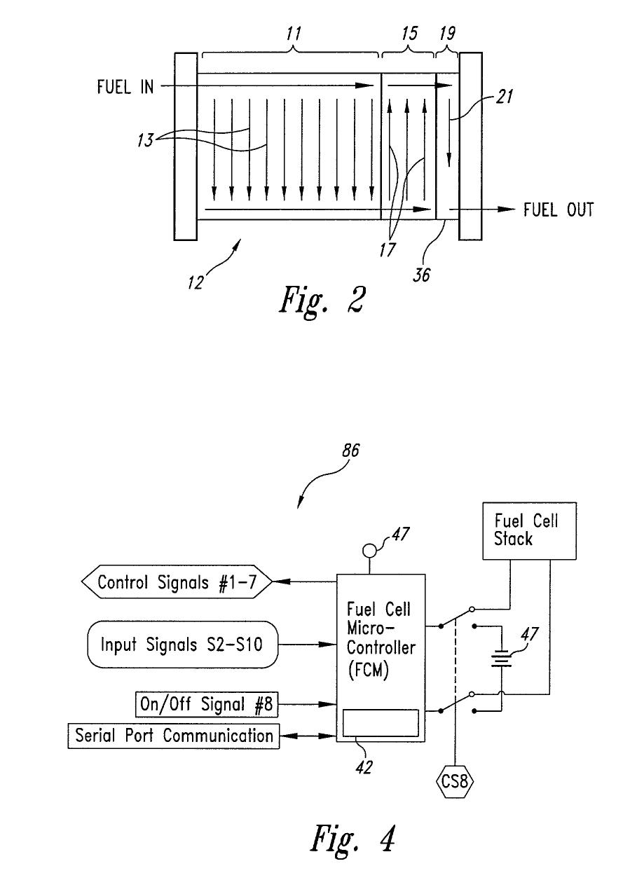

In one embodiment, the fuel cell stack 12 includes forty-seven fuel cell assemblies 16. (FIGS. 1 and 2 omit a number of the fuel cell assemblies 16 to enhance drawing clarity). The fuel cell stack 12 can include a greater or lesser number of fuel cell assemblies to provide more or less power, respectively.

As shown in FIG. 2, fuel is directed through fuel cell stack 12 in a cascaded flow pattern. A first set 11 composed of the first forty-three fuel cell assemblies 16 are arranged so that fuel flows within the set in a concurrent parallel direction (represented by arrows 13) that is generally opposite the direction of the flow of coolant through fuel cell stack 12. Fuel flow through a next set 15 of two fuel cell assemblies 16 is in series with respect to the flow of fuel in the first set 11, and in a concurrent parallel direction within the set 15 (in a direction represented by arrows 17) that is generally concurrent with the direction of the flow of coolant through fuel cell stack 12. Fuel flow through a final set 19 of two fuel cells assemblies 16 is in series with respect to the first and second sets 11, 15, and in a concurrent parallel direction within the set 19 (in a direction represented by arrow 21) generally opposite the flow of coolant through the fuel cell stack 12. The oxidant is supplied to each of the forty-seven fuel cells in parallel, in the same general direction as the flow of coolant through the fuel cell stack 12.

The final set 19 of one or more fuel cell assemblies 16 comprises the purge cell portion 36 of the fuel cell stack. The purge cell portion 36 accumulates non-reactive components which are periodically vented by opening a purge valve, discussed below.

Each membrane electrode assembly 20 is designed to produce a nominal potential difference of about 0.6 V between anode 22 and cathode 24. Reactant streams (hydrogen and air) are supplied to electrodes 22, 24 on either side of ion exchange membrane 26 through reactant channels 30. Hydrogen is supplied to anode 22, where platinum catalyst 27 promotes its separation into protons and electrons, which pass as useful electricity through an external circuit (not shown). On the opposite side of membrane electrode assembly 20, air flows through reactant channels 30 to cathode 24 where oxygen in the air reacts with protons passing through the ion exchange membrane 26 to produce product water.

Fuel Cell System Sensors and Actuators

With continuing reference to FIG. 1, the electronic monitoring and control system 14 comprises various electrical and electronic components on a circuit board 38 and various sensors 44 and actuators 46 distributed throughout fuel cell system 10. The circuit board 38 carries a microprocessor or microcontroller 40 that is appropriately programmed or configured to carry out fuel cell system operation. Microcontroller 40 can take the form of an Atmel AVR RISC microcontroller available from Atmel Corporation of San Jose, Calif. The electronic monitoring and control system 14 also includes a persistent memory 42, such as an EEPROM portion of microcontroller 40 or discrete nonvolatile controller-readable media.

Microcontroller 40 is coupled to receive input from sensors 44 and to provide output to actuators 46. The input and/or output can take the form of either digital and/or analog signals. A rechargeable battery 47 powers the electronic fuel cell monitoring and control system 14 until fuel cell stack 12 can provide sufficient power to the electronic monitoring and control system 14. Microcontroller 40 is selectively couplable between fuel cell stack 12 and battery 47 for switching power during fuel cell system operation and/or to recharge battery 47 during fuel cell operation.

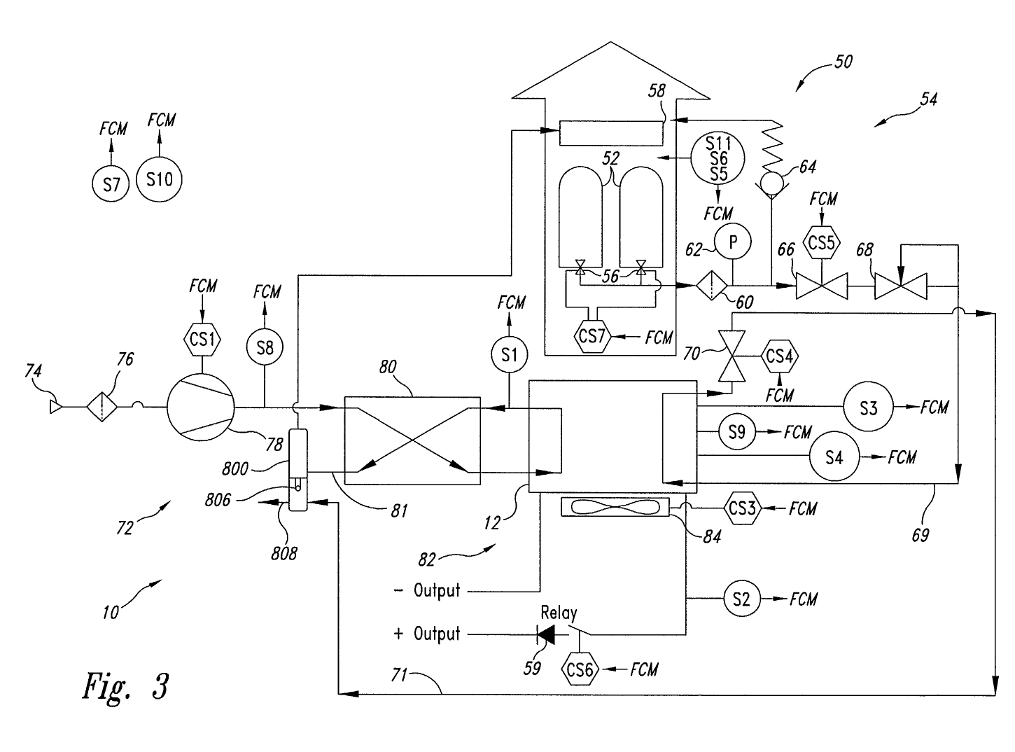

FIG. 3 show various elements of fuel cell system 10 schematically in further detail, and shows various other elements that were omitted from FIG. 1 for clarity of illustration.

With particular reference to FIG. 3, fuel cell system 10 provides fuel (e.g., hydrogen) to anode 22 by way of a fuel system 50. Fuel system 50 includes a source of fuel such as one or more fuel tanks 52, and a fuel regulating system 54 for controlling delivery of the fuel. Fuel tanks 52 can contain hydrogen, or some other fuel such as methanol. Alternatively, fuel tanks 52 can represent a process stream from which hydrogen can be derived by reforming, such as methane or natural gas (in which case a reformer is provided in fuel cell system 10).

Fuel tanks 52 each include a fuel tank valve 56 for controlling the flow of fuel from the respective fuel tank 52. Fuel tank valves 56 may be automatically controlled by microcontroller 40, and/or manually controlled by a human operator. Fuel tanks 52 may be refillable, or may be disposable. Fuel tanks 52 may be integral to fuel system 50 and/or the fuel cell system 10, or can take the form of discrete units. In this embodiment, the fuel tanks 52 are hydride storage tanks. Fuel tanks 52 are positioned within the fuel cell system 10 such that they are heatable by exhaust cooling air warmed by heat generated by fuel cell stack 12. Such heating facilitates the release of hydrogen from the hydride storage media.

Fuel cell monitoring and control system 14 includes a hydrogen concentration sensor S5, hydrogen heater current sensor S6 and a hydrogen sensor check sensor S11. Hydrogen heater current sensor S6 can take the form of a current sensor that is coupled to monitor a hydrogen heater element that is an integral component of hydrogen concentration sensor S5. Hydrogen sensor check sensor S11 monitors voltage across a positive leg of a Wheatstone bridge in the hydrogen concentration sensor S5, discussed below, to determine whether hydrogen concentration sensor S5 is functioning.

The fuel tanks 52 are coupled to fuel regulating system 54 through a filter 60 that ensures that particulate impurities do not enter fuel regulating system 54. Fuel regulating system 54 includes a pressure sensor 62 to monitor the pressure of fuel in fuel tanks 52, which indicates how much fuel remains in fuel tanks 52. A pressure relief valve 64 automatically operates to relieve excess pressure in fuel system 50. Pressure relief valve 64 can take the form of a spring and ball relief valve. A main gas solenoid CS5 opens and closes a main gas valve 66 in response to signals from microcontroller 40 to provide fluid communication between fuel tanks 52 and fuel regulating system 54. Additional solenoids CS7 control flow through the fuel tank valves 56. A hydrogen regulator 68 regulates the flow of hydrogen from fuel tanks 52. Fuel is delivered to the anodes 22 of the fuel cell assemblies 16 through a hydrogen inlet conduit 69 that is connected to fuel stream inlet port of stack 12.

Sensors 44 of fuel regulating system 54 monitor a number of fuel cell system operating parameters to maintain fuel cell system operation within acceptable limits. For example, a stack voltage sensor S3 measures the gross voltage across fuel cell stack 12. A purge cell voltage sensor S4 monitors the voltage across purge cell portion 36 (the final set 19 of fuel cell assemblies 16 in cascaded design of FIG. 2). A cell voltage checker S9 ensures that a voltage across each of fuel cells 20 is within an acceptable limit. Each of sensors S3, S4, S9 provide inputs to microcontroller 40, identified in FIG. 3 by arrows pointing toward the blocks labeled “FCM” (i.e., fuel cell microcontroller 40).

A fuel purge valve 70 is provided at the fuel stream outlet port 35 of fuel cell stack 12 and is typically in a closed position when stack 12 is operating. Fuel is thus supplied to fuel cell stack 12 only as needed to sustain the desired rate of electrochemical reaction. Because of the cascaded flow design, any impurities (e.g., nitrogen) in the supply fuel stream tend to accumulate in purge cell portion 36 during operation. A build-up of impurities in purge cell portion 36 tends to reduce the performance of purge cell portion 36. Should the purge cell voltage sensor S4 detect a performance drop below a threshold voltage level, microcontroller 40 may send a signal to a purge valve controller CS4 such as a solenoid to open purge valve 36 and discharge the impurities, unreacted hydrogen, and other matter that may have accumulated in purge cell portion 36 (hereinafter collectively referred to as “purge discharge”). The venting of hydrogen by the purge valve 70 during a purge is limited to less than 1 liter/minute on a continuous basis to prevent the ambient environment monitoring and control systems, discussed below, from triggering a failure or fault.

Fuel cell system 10 provides oxygen in an air stream to the cathode side of membrane electrode assemblies 20 by way of an oxygen delivery system 72. A source of oxygen or air 74 can take the form of an air tank or the ambient atmosphere. A filter 76 ensures that particulate impurities do not enter oxygen delivery system 72. An air compressor controller CS1 controls an air compressor 78 to provide the air to fuel cell stack 12 at a desired flow rate. A mass air flow sensor S8 measures the air flow rate into fuel cell stack 12, providing the value as an input to microcontroller 40. A humidity exchanger 80 adds water vapor to the air to keep the ion exchange membrane 26 moist. Humidity exchanger 80 also removes water vapor which is a byproduct of the electrochemical reaction. Excess liquid water is provided to an evaporator 58 via conduit 81.

Exhaust oxidant discharged from stack 12 is directed through humidity exchanger 80, wherein some water is removed from the exhaust oxidant stream for use in humidifying the incoming oxidant stream. The exhaust oxidant is then directed to a product water pumping system that uses a hydrogen purge discharge exhausted from stack 12 via purge valve 70 to pump product water out of the fuel cell system 10.

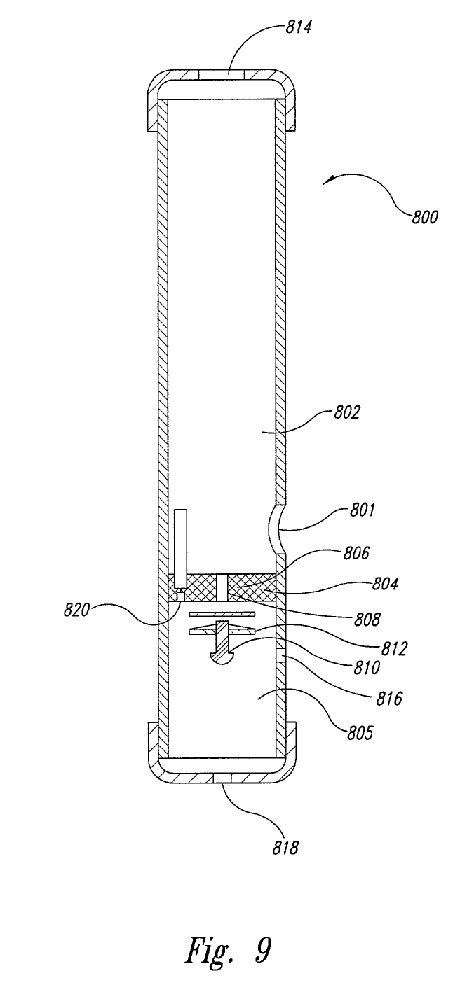

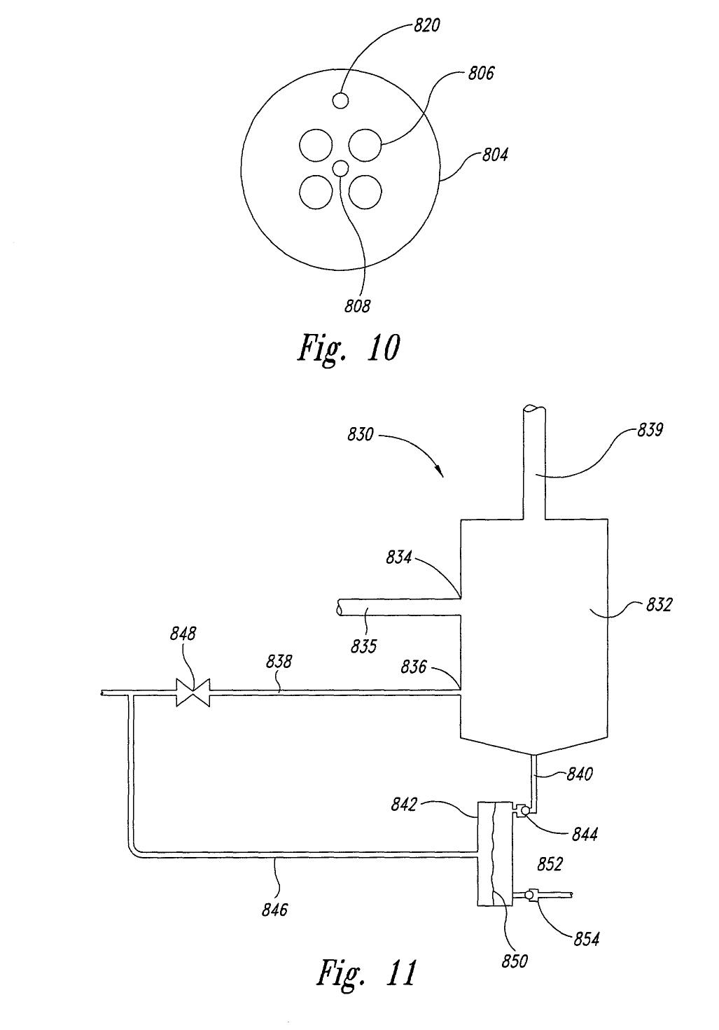

The product water pumping system comprises a containment tank 800 that is illustrated in detail in FIGS. 9 and 10. Containment tank 800 is separated by a partition 804 into two chambers, namely, an oxidant exhaust chamber 802 and a product water pumping chamber 805. Exhaust oxidant from stack 12 typically enters oxidant exhaust chamber 802 via oxidant inlet 801 at or slightly above atmospheric pressure, and is discharged from containment tank 800 through an oxidant exhaust outlet 814 and into the cooling air exhaust stream for dilution and eventual discharge outside fuel cell system 10. Alternatively, the exhaust oxidant may be directed to an evaporator 58 before being discharged outside fuel cell system 10. The oxidant exhaust is typically saturated with product water vapor and also carries liquid product water from the stack. When the oxidant exhaust enters oxidant exhaust chamber 802, product water tends to separate from the oxidant exhaust stream and collects at the bottom of oxidant exhaust chamber 802.

Partition 804 is provided with a plurality of water drains 806 disposed around a threaded bore 808 that accepts a screw 810. Screw 810 holds a flexible fluid impermeable seal 812 that is normally biased against the water chamber side of partition 804 so as to cover drains 806, thereby acting as a one-way check valve that allows the one-way flow of product water from oxidant exhaust chamber 802 into product water pumping chamber 805. The seal 812 is designed to open under a selected weight of collected product water, thereby allowing the water to drain into product water pumping chamber 805.

Certain variations in the design of product water containment tank 800 will occur to a person skilled in the art and be within the scope of this invention. For example, the number, size and shape of drain openings, and the type of check valve may be varied.

Product water pumping chamber 805 is provided with a pump fluid inlet 816 and a product water outlet 818. A purge fluid conduit 71 (FIG. 3) connects the purge valve 70 to pump fluid inlet 816 so that when purge valve 70 is momentarily opened to release the purge discharge from the stack 12, the purge discharge is transmitted under pressure (typically about 2-3 psi) into product water pumping chamber 805. The pressurized purge discharge causes seal 812 to close against partition 804, thereby momentarily pressurizing the product water pumping chamber 805. The pressurization pumps the product water collected in product water pumping chamber 805 out of product water pumping chamber 805 through product water outlet 818.

By pumping the product water out of fuel cell system 10, the product water can be transported to a location remote from or higher than fuel cell system 10. Pumping may also reduce gurgling or other noises that sometimes accompany gravity-based water discharges. By using the pressurized purge discharge as a pumping means, the use of a dedicated electric pump or similar device can be avoided. As the purge valve can be opened while the system is operating, the product water discharge operation can be performed without the need to shut the fuel cell system off.

A pressure equalization port 820 is provided in partition 804 to allow gases to flow slowly out of water pumping chamber 805 into the oxidant exhaust chamber 802, thereby eventually equalizing the pressure between the oxidant exhaust chamber 802 and the water pumping chamber 805.

A second embodiment of a product water pumping system 830 is illustrated in FIG. 11. A reactant exhaust chamber 832 has an inlet 834 for receiving exhaust oxidant from a fuel cell stack via an oxidant conduit 835, an inlet 836 for receiving a hydrogen purge discharge from the stack via a hydrogen purge discharge conduit 838, and an outlet 839 for exhausting the oxidant and hydrogen purge discharge from fuel cell system 10. Water in both the exhaust oxidant and hydrogen purge discharges collects in this reactant exhaust chamber 832. A drain 840 at the bottom of reactant exhaust chamber 832 connects to a product water pumping chamber 842; a check valve 844 in drain 840 allows a one way flow of product water from reactant exhaust chamber 832 to pumping chamber 842.

Upstream of reactant exhaust chamber 832, a fuel flow conduit 846 branches off from fuel flow conduit 838 and connects to pumping chamber 842. A purge valve 848 is provided on fuel conduit 838 downstream of the intersection of the conduits 846 and 838. When purge valve 848 is closed, hydrogen purge discharge from stack is dead-ended at pumping chamber 842 under stack pressure. A flexible fluid-impermeable diaphragm 850 in pumping chamber 842 separates the hydrogen purge discharge from the product in the pumping chamber 842. During stack operation and when purge valve 848 is closed, the pressure of the fuel displaces the diaphragm, thereby pumping the product water from pumping chamber 842 out of fuel cell system 10 via an outlet 852 and a check valve 854. When purge valve 848 is opened, the purge discharge is directed into reactant exhaust chamber 832 for water separation, and discharged from fuel cell system 10.

Fuel cell system 10 removes excess heat from fuel cell stack 12 and uses the excess heat to warm fuel in fuel tanks 52 by way of a cooling system 82. Cooling system 82 includes a fuel cell temperature sensor S1, for example a thermister that monitors the core temperature of the fuel cell stack 12. The temperature is provided as input to microcontroller 40. A stack current sensor S2, for example a Hall sensor, measures the gross current through fuel cell stack 12, and provides the value of the current as an input to microcontroller 40. A cooling fan controller CS3 controls the operation of one or more cooling fans 84 for cooling fuel cell stack 12. After passing through fuel cell stack 12, the warmed cooling air circulates around fuel tanks 52 to warm the fuel. The warmed cooling air then passes through the evaporator 58. A power relay controller CS6 such as a solenoid connects, and disconnects, the fuel cell stack to, and from, an external circuit in response to microcontroller 40. A power diode 59 provides one-way isolation of fuel cell system 10 from the external load to provide protection to fuel cell system 10 from the external load. A battery relay controller CS8 connects, and disconnects, fuel cell monitoring and control system 14 between the fuel cell stack 12 and the battery 47.

The fuel cell monitoring and control system 14 (illustrated in FIG. 4) includes sensors for monitoring fuel cell system 10 surroundings and actuators for controlling fuel cell system 10 accordingly. For example, a hydrogen concentration sensor S5 (shown in FIG. 3) for monitoring the hydrogen concentration level in the ambient atmosphere surrounding fuel cell stack 12. The hydrogen concentration sensor S5 can take the form of a heater element with a hydrogen sensitive thermister that may be temperature compensated. An oxygen concentration sensor S7 (illustrated in FIG. 4) to monitor the oxygen concentration level in the ambient atmosphere surrounding fuel cell system 10. An ambient temperature sensor S10 (shown in FIG. 3), for example a digital sensor, to monitor the ambient air temperature surrounding fuel cell system 10.

With reference to FIG. 4, microcontroller 40 receives the various sensor measurements such as ambient air temperature, fuel pressure, hydrogen concentration, oxygen concentration, fuel cell stack current, air mass flow, cell voltage check status, voltage across the fuel cell stack, and voltage across the purge cell portion of the fuel cell stack from various sensors described below. Microcontroller 40 provides the control signals to the various actuators, such as air compressor controller CS1, cooling fan controller CS3, purge valve controller CS4, main gas valve solenoid CS5, power circuit relay controller CS6, hydride tank valve solenoid CS7, and battery relay controller CS8.

Fuel Cell System Structural Arrangement

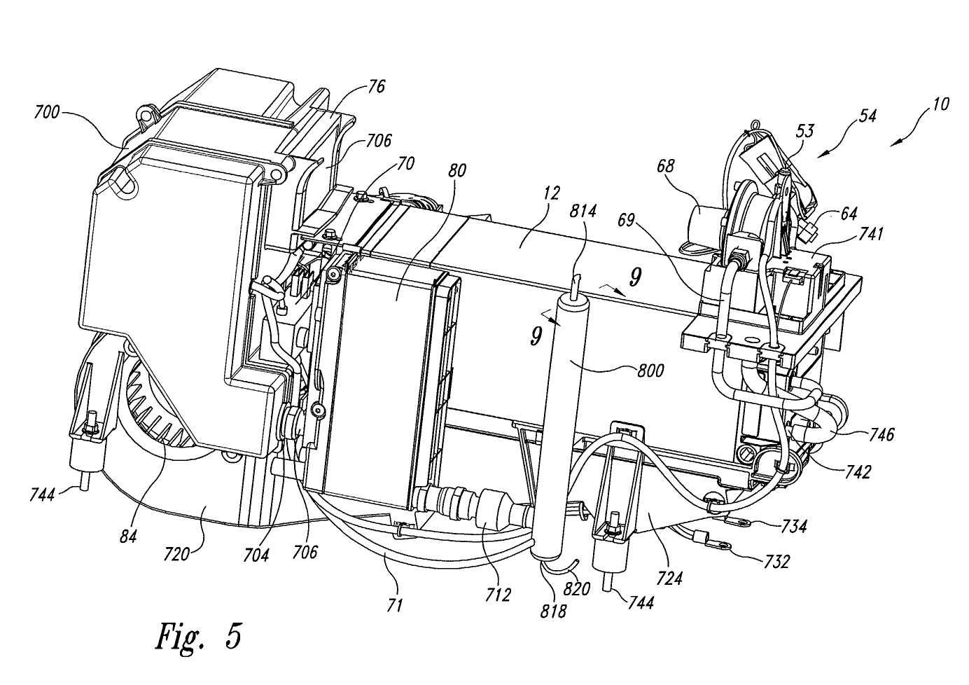

FIGS. 5-8 illustrate the structural arrangement of the components in fuel cell system 10. For convenience, “top”, “bottom”, “above”, “below” and similar descriptors are used merely as points of reference in the description, and while corresponding to the general orientation of fuel cell system 10 during operation, are not to be construed to limit the orientation of fuel cell system 10 during operation or otherwise.

Referring to FIGS. 5-7, air compressor 78 and cooling fan 84 are grouped together at one end (“air supply end”) of fuel cell stack 12. Fuel tanks 52 (not shown in FIGS. 5-7) are mountable to fuel cell system 10 on top of, and along the length of, fuel cell stack 12. The components of fuel regulating system 54 upstream of fuel cell stack 12 are located generally at the end of stack 12 (“hydrogen supply end”) opposite the air supply end.

Air compressor 78 is housed within an insulated housing 700 that is removably attached to fuel cell stack 12 at the air supply end. Housing 700 has an air supply aperture 702 covered by the filter 76 that allows supply air into housing 700. Air compressor 78 is a positive displacement low pressure type compressor and is operable to transmit supply air to air supply conduit 81 at a flow rate controllable by the operator. An air supply conduit 81 passes through a conduit aperture 704 in compressor housing 700 and connects with an air supply inlet 706 of humidity exchanger 80. Mass flow sensor S8 is located on an inlet of air compressor 78 upstream of the humidity exchanger 81 and preferably within the compressor housing 700.

The humidity exchanger 80 may be of the type disclosed in U.S. Pat. No. 6,106,964, and is mounted to one side of the fuel cell stack 12 near the air supply end. Air entering into humidity exchanger 80 via air supply conduit 81 is humidified and then exhausted from humidity exchanger 80 and into fuel cell stack 12 (via the supply air inlet port of the end plate 18b). Exhaust air from fuel cell stack 12 exits via the exhaust air outlet port in end plate 18b and into the humidity exchanger 80, where water in the air exhaust stream is transferred to the air supply stream. The air exhaust stream then leaves the humidity exchanger 80 via the air exhaust outlet 712.

The cooling fan 84 is housed within a fan housing 720 that is removably mounted to the air supply end of fuel cell stack 12 and below the compressor housing 700. Fan housing 720 includes a duct 724 that directs cooling air from cooling fan 84 to the cooling channel openings at the bottom of the fuel cell stack 12. Cooling air is directed upwards and through fuel cell stack 12 via the cooling channels 30 and is discharged from the cooling channel openings at the top of the fuel cell stack 12. During operation, heat extracted from fuel cell stack 12 by the cooling air is used to warm hydride tanks 52 that are mountable directly above and along the length of stack 12. Some of the warmed cooling air is redirected into the air supply aperture 702 of the compressor housing 700 for use as oxidant supply air.

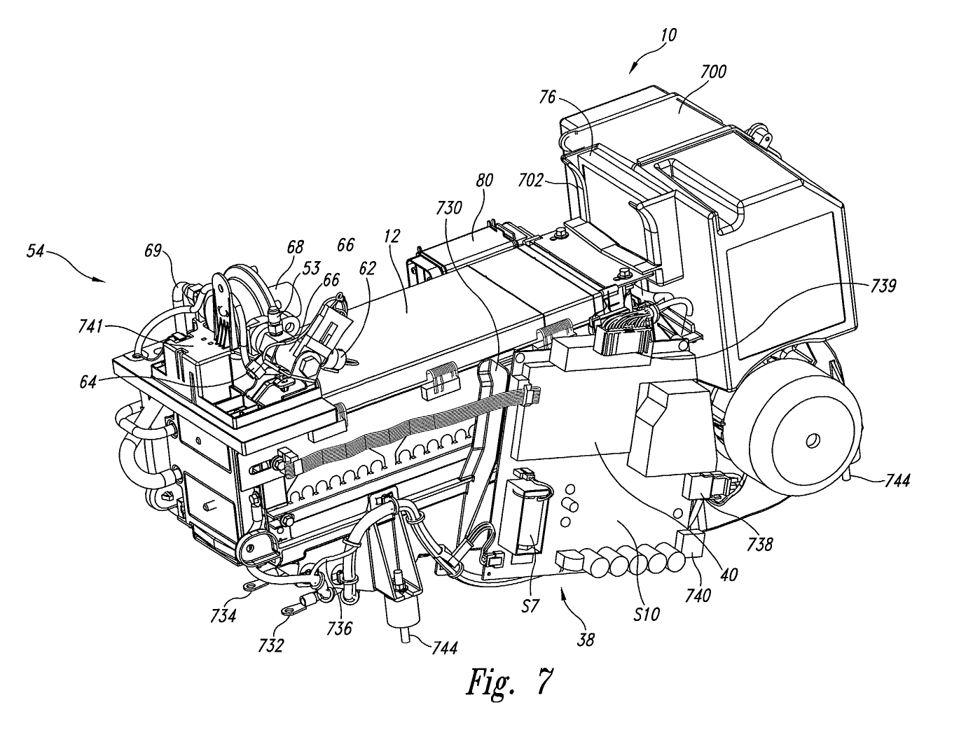

Referring particularly to FIG. 7, circuit board 38 carrying microcontroller 40, oxygen sensor S7 and ambient temperature sensor S10 is mounted on the side of fuel cell stack 12 opposite humidity exchanger 80 by way of a mounting bracket 730. Positive and negative electrical power supply lines 732, 734 extend from each end of fuel cell stack 12 and are connectable to an external load. An electrically conductive bleed wire 336 from each of the power supply lines 732, 734 connects to circuit board 38 at a stack power in terminal 738 and transmits some of the electricity generated by fuel cell stack 12 to power the components on the circuit board 38, as well as sensors 44 and actuators 46 which are electrically connected to circuit board 38 at terminal 739. Similarly, battery 47 (not shown in FIGS. 5-7) is electrically connected to circuit board 38 at battery power in terminal 740. Battery 47 supplies power to the circuit board components, sensors 44 and actuators 46 when fuel cell stack output has not yet reached nominal levels (e.g, at start-up); once fuel cell stack 12 has reached nominal operating conditions, the fuel cell stack 12 can also supply power to recharge battery 47.

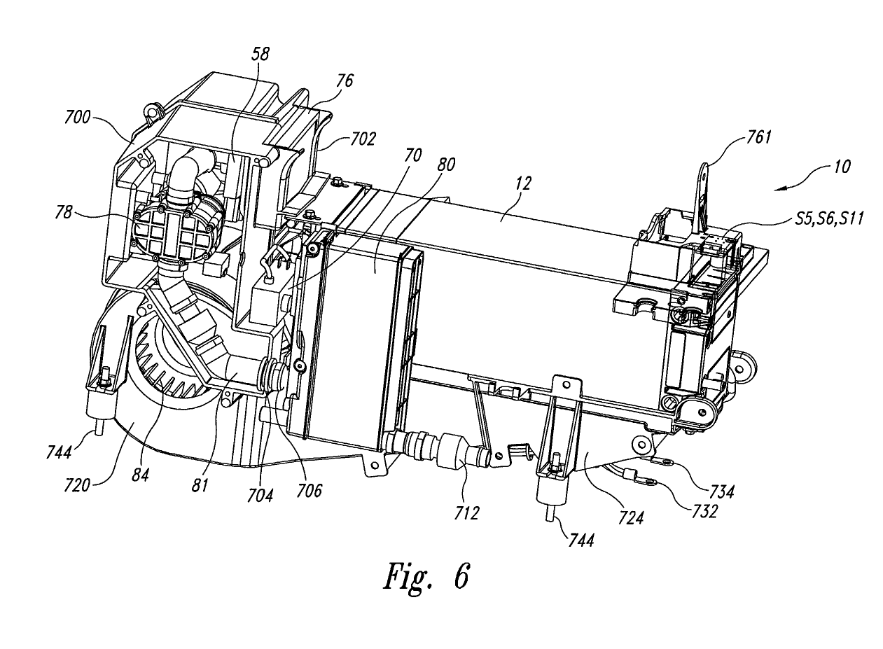

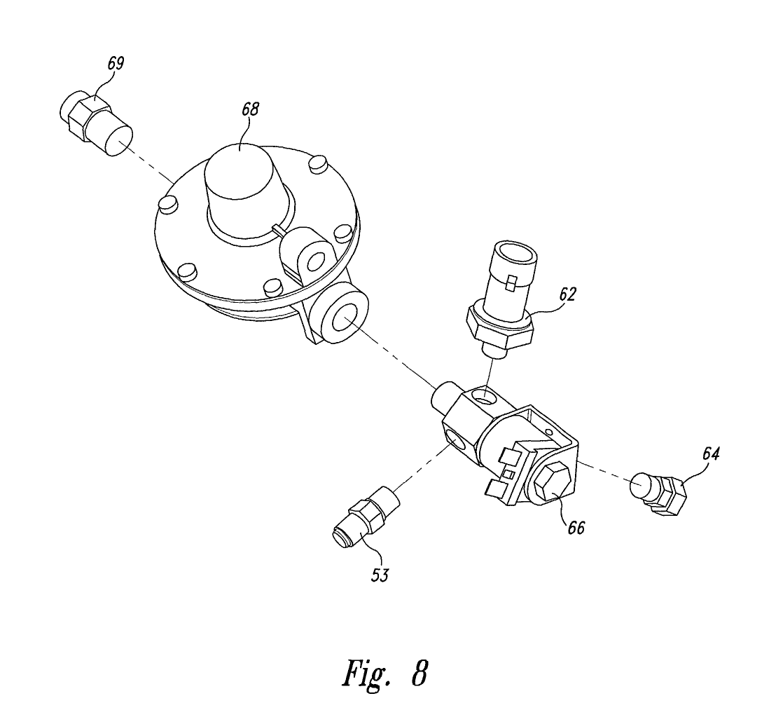

Referring generally to FIGS. 5-7 and particularly to FIG. 8, a bracket 741 is provided at the hydrogen supply end for the mounting of a fuel tank valve connector 53, hydrogen pressure sensor 62, pressure relief valve 64, main gas valve 66, and hydrogen pressure regulator 68 above the fuel cell stack 12 at the hydrogen supply end. A suitable pressure regulator may be a Type 912 pressure regulator available from Fisher Controls of Marshalltown, Iowa. A suitable pressure sensor may be a transducer supplied Texas Instruments of Dallas, Tex. A suitable pressure relief valve may be supplied by Schraeder-Bridgeport of Buffalo Grove, Ill. The pressure relief valve 64 is provided for the hydride tanks 52 and may be set to open at about 350 psi. A low pressure relief valve 742 is provided for fuel cell stack 12 and is set to open at about 15 psi. Bracket 741 also provides a mount for hydrogen concentration sensor S5, hydrogen heater current sensor S6 and hydrogen sensor check sensor S11, which are visible in FIG. 6 in which the bracket 741 is transparently illustrated in hidden line. The hydride tanks 52 are connectable to the fuel tank connector 53. When the fuel tank and main gas valves 56, 66 are opened, hydrogen is supplied under a controlled pressure (monitored by pressure sensor 62 and adjustable by hydrogen pressure regulator 68) through the fuel supply conduit 69 to the fuel inlet port 35 of end plate 18a. The purge valve 70 is located at the fuel outlet port at end plate 18b.

Referring particularly to FIG. 5, water containment tank 800 is mounted to fuel cell system 10 in the vicinity of humidity exchanger 80. Purge conduit 71 connects purge valve 70 to containment tank 800. Exhaust oxidant discharged from humidity exchanger is transmitted into containment tank 800 via exhaust outlet 712. Exhaust oxidant leaves containment tank 800 via oxidant exhaust outlet 814, which may be connected to evaporator 58 (not shown in FIGS. 5-7) mountable to a cover (not shown) above fuel cell stack 12. Product water and purge fluid is discharged from containment tank 800 via fluid outlet 818, through conduit 820, and away from fuel cell system 10.

The fuel cell system 10 and hydride tanks 52 are housed within a system cover (not shown) and coupled to a base (not shown) at mounting points 744. The portion of the cover covering the stack 12 and fuel regulating system 54 is shaped so that cooling air exhausted from the top of the fuel cell stack 12 is directed by this portion of the cover to either the supply air inlet 702 or over fuel regulating system 54.

The fuel cell system 10 is designed so that components that are designed to discharge hydrogen or that present a risk of leaking hydrogen, are as much as practicable, located in the cooling air path or have their discharges/leakages directed to the cooling air path. The cooling air path is defined by duct 724, cooling air channels of stack 12, and the portion of the system cover above stack 12. The components directly in the cooling air path include fuel tanks 52, and components of fuel regulating system 54 such as pressure relief valve 64, main gas valve 66, and hydrogen regulator 68. Components not directly in the cooling air path are fluidly connected to the cooling air path, and include purge valve 70 connected to duct 724 via purge conduit (not shown) and low pressure relief valve 742 connected to an outlet near fuel regulating system 54 via conduit 746. When cooling air fan 84 is operational, the cooling air stream carries leaked/discharged hydrogen through duct 724, past stack 12, and out of system 10. Hydrogen concentration sensor S5 is strategically placed as far downstream as possible in the cooling air stream to detect hydrogen carried in the cooling air stream.

Hydrogen concentration sensor S5 is also placed in the vicinity of the components of fuel regulating system 54 to improve detection of hydrogen leaks/discharges from fuel regulating system 54.

In operation, the hydrogen concentration in the ambient air surrounding the fuel cell stack 12 is monitored by the hydrogen concentration sensor S5. The microcontroller 40 is programmed to execute a hydrogen concentration monitoring method wherein the hydrogen concentration sensor S5 is read or sampled to determine the ambient hydrogen concentration; the microcontroller 40 may read or sample the hydrogen concentration sensor S5 every one-thousand microseconds. If the measured ambient hydrogen concentration exceeds a hydrogen concentration failure threshold, the fuel cell system operation is stopped. A suitable hydrogen concentration failure threshold for the described embodiment is approximately 10,000 parts per million. If the hydrogen concentration reading is less than the hydrogen concentration failure threshold, the microcontroller 40 terminates the hydrogen concentration monitoring method; the method may be executed repeatedly at predetermined intervals.

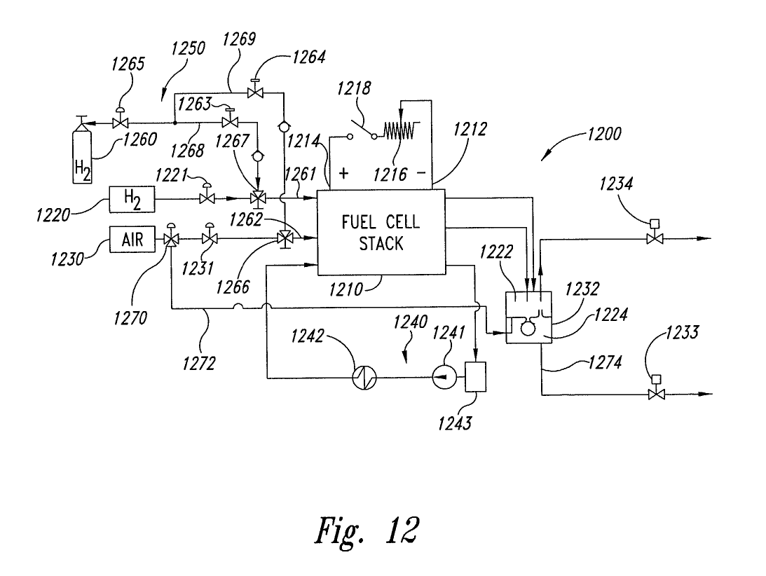

The product water pump system as described generally applies to fuel cell systems employing dead-ended hydrogen operation, wherein hydrogen is intermittently purged from the system. However, the product water pump system may also be suitable for fuel cell systems such as the system 1200 illustrated in FIG. 12. In this fuel cell system, fuel cell stack 1210 is purged by nitrogen or another inert gas from a purge system 1250 and is cooled by a water-based coolant. Fuel cell stack 1210 includes negative and positive bus plates 1212, 1214, respectively, to which an external circuit comprising a variable load 1216 is electrically connectable by closing switch 1218. The system includes a fuel (hydrogen) circuit, an oxidant (air) circuit, and a coolant (water) circuit. The reactant and coolant streams are circulated in the system 1200 in various conduits illustrated schematically in FIG. 12.

Purge system 1250 is used to purge hydrogen and oxidant passages in fuel cell stack 1210 to remove excess water from the inside of the stack. Nitrogen purge gas from a purge gas supply 1260 to the hydrogen and air inlet passages 1261, 1262 is transmitted through purge supply conduits 1268, 1269 and three way valves 1266, 1267 connected to respective hydrogen and air inlet passages 1261, 1262 upstream of stack 1210. The flow of nitrogen is controlled by respective flow regulating valves 1263, 1264 and 1265.

A hydrogen supply 1220 is connected to stack 1210; hydrogen pressure is controllable by pressure regulator 1221. Water in the hydrogen exhaust stream exiting stack 1210 is accumulated in a reactant exhaust chamber 1222 of a containment tank 1232. The fuel cell stack 1210 may operate on a dead-ended cascaded design as described in the previous embodiment, in which case, only trace amounts of unreacted hydrogen should be present in the hydrogen exhaust stream. Such hydrogen is exhausted from the containment tank 1232 via valve 1234.

An air compressor 1230 is connected to supply air to stack 1210, the pressure of the air supply being controllable by pressure regulator 1231. By controlling valves 1270, 1231 and 1266 appropriately, oxidant air is supplied to stack 1210 via oxidant supply conduit 1262. Water in the exhaust air stream exiting the stack 1210 is accumulated in a reactant exhaust chamber 1222 of a product water containment tank 1232. As discussed in the previous embodiment, product water will drain into a product water pumping chamber 1224 of the containment tank 1232. Exhaust air is discharged from containment tank 1232 and fuel cell system 1200 via valve 1234.

The pressurized fluid used to pump the product water out of product water pumping chamber 1224 can be one of oxidant air, fuel, or nitrogen. Given that the supply of nitrogen and hydrogen fluids are limited to the amounts stored on board fuel cell system 1200, it may be preferable to use oxidant air. In this connection, some air from the compressor 1230 is directable via valve 1270 through conduit 1272 and to product water pumping chamber 1224. This compressed air is used to discharge product water under pressure out of system 1200 via product water discharge conduit 1274. The flow of the product water discharge is controllable by valve 1233.

In the coolant water loop 1240, water is pumped from containment tanks 1232 and circulated through stack 1210 by pump 1241. The temperature of the water is adjusted in a heat exchanger 1242; coolant fluid is storable in tank 1243.

Alternatively, reactant streams themselves can be employed as the purge streams, thereby replacing the need for nitrogen purge system 1250. Preferably the purge fluid, if it is a gas, is dry or at least not humidified. Thus, when employing the reactant streams as the purge streams, reactant stream humidifiers if present in the system are bypassed to provide streams having water carrying capacity greater than humidified reactant streams. A humidifier may be bypassed by reducing (or stopping) the amount of water transferred to a reactant stream passing through the humidifier, or by directing the reactant stream around the humidifier so that the reactant stream is fluidly isolated from the humidifier.

Although specific embodiments, and examples for, the invention are described herein for illustrative purposes, various equivalent modifications can be made without departing from the spirit and scope of the invention, as will be recognized by those skilled in the relevant art. The teachings provided herein of the invention can be applied to other fuel cell systems, not necessarily the PEM fuel cell system described above.

Commonly assigned U.S. patent applications Ser. No. 09/______, entitled FUEL CELL AMBIENT ENVIRONMENT MONITORING AND CONTROL APPARATUS AND METHOD (Atty. Docket No. 130109.404); Ser. No. 09/______, entitled FUEL CELL CONTROLLER SELF INSPECTION (Atty. Docket No. 130109.405); Ser. No. 09/______, entitled FUEL CELL ANOMALY DETECTION METHOD AND APPARATUS (Atty. Docket No. 130109.406); Ser. No. 09/______, entitled FUEL CELL PURGING METHOD AND APPARATUS (Atty. Docket No. 130109.407); Ser. No. 09/______, entitled FUEL CELL RESUSCITATION METHOD AND APPARATUS (Atty. Docket No. 130109.408); Ser. No. 09/______, entitled FUEL CELL SYSTEM METHOD, APPARATUS AND SCHEDULING (Atty. Docket No. 130109.409); Ser. No. 09/______, entitled FUEL CELL SYSTEM AUTOMATIC POWER SWITCHING METHOD AND APPARATUS (Atty. Docket No. 130109.421); and Ser. No. 09/______, entitled FUEL CELL SYSTEM HAVING A HYDROGEN SENSOR (Atty. Docket No. 130109.429), all filed Jul. 25, 2001, are incorporated herein by reference, in their entirety.

The various embodiments described above and in the applications and patents incorporated herein by reference can be combined to provide further embodiments. The described methods can omit some acts and can add other acts, and can execute the acts in a different order than that illustrated, to achieve the advantages of the invention.

These and other changes can be made to the invention in light of the above detailed description. In general, in the following claims, the terms used should not be construed to limit the invention to the specific embodiments disclosed in the specification, but should be construed to include all fuel cell systems, controllers and processors, actuators, and sensors that operate in accordance with the claims. Accordingly, the invention is not limited by the disclosure, but instead its scope is to be determined entirely by the following claims.

1. An electric power generation system, comprising
a fuel cell stack comprising at least one solid polymer fuel cell;
an oxidant flow path to and from the stack;
a fuel flow path to and from the stack; and,
a product water pumping system comprising a reactant exhaust chamber, a product water pumping chamber, a drain for fluidly coupling the reactant exhaust chamber to the product water pumping chamber, and a valve positioned for controlling the flow of water through the drain from the reactant exhaust chamber to the product water pumping chamber, the reactant exhaust chamber having an inlet connected to the oxidant flow path from the stack for flowing oxidant exhaust into the reactant exhaust chamber, and an outlet for discharging oxidant exhaust from the reactant exhaust chamber, and, the product water pumping chamber having an inlet coupled to the fuel flow path from the stack, and an outlet, wherein product water collected in the product water pumping chamber is pumped through the outlet by a purge discharge flowing into the product water pumping chamber via the inlet.

2. The electric power generation system of claim 1 wherein the valve is a one-way valve.

3. The electric power generation system of claim 2 wherein the reactant exhaust chamber and the product water pumping chamber are combined in a single product water containment tank, the tank including a partition that, when the valve is closed, separates the reactant exhaust chamber from the product water pumping chamber.

4. The electric power generation system of claim 3 wherein the drain is formed in the partition.

5. The electric power generation system of claim 4, further comprising:
a pressure equalization port formed in the partition for equalizing the pressure between the reactant exhaust chamber and the product water pumping chamber.

6. The electric power generation system of claim 2 wherein the reactant exhaust chamber inlet is also connected to the fuel flow path from the stack.

7. The electric power generation system of claim 6, further comprising:
a purge valve in the fuel flow path from the stack, the purge valve being operable to selectively direct purge discharge from the stack to at least one of the reactant exhaust chamber and the product water pumping chamber.

8. The electric power generation system of claim 7, further comprising:
a flexible fluid-impermeable diaphragm that provides a fluid seal between a portion of the product water pumping chamber having the inlet, and a portion of the product water pumping chamber having the drain and the outlet, such that a displacement of the diaphragm by a flow of purge discharge into the product water pumping chamber pumps product water in the product water pumping chamber through the outlet.

9. A product water pumping system for an electric power generation system comprising a fuel cell stack comprising at least one solid polymer fuel cell; an oxidant flow path to and from the stack; and a fuel flow path to and from the stack, the product water pumping system, the product water pumping system comprising:
a reactant exhaust chamber;
a product water pumping chamber;
a drain for fluidly coupling the reactant exhaust chamber to the product water pumping chamber; and,
a valve positioned for controlling the flow of water through the drain from the reactant exhaust chamber to the product water pumping chamber,
the reactant exhaust chamber having an inlet connected to the oxidant flow path from the stack and for flowing oxidant exhaust into the reactant exhaust chamber, and an outlet for discharging oxidant exhaust from the reactant exhaust chamber, and, the product water pumping chamber having an inlet connected to the fuel flow path from the stack, and an outlet, wherein product water collected in the product water pumping chamber is pumped through the outlet by purge discharge flowing into the product water pumping chamber via the inlet.

10. The product water pumping system of claim 9 wherein the valve is a one-way valve.

11. The product water pumping system of claim 10 wherein the reactant exhaust chamber and the product water pumping chamber are combined in a single product water containment tank, the tank including a partition that, when the valve is closed, separates the reactant exhaust chamber from the product water pumping chamber.

12. The product water pumping system of claim 11 the drain is formed in the partition.

13. The product water pumping system of claim 12, further comprising:
a pressure equalization port formed in the partition for equalizing the pressure between the reactant exhaust chamber and the product water pumping chamber.

14. The product water pumping system of claim 10, further comprising:
an inlet formed in the reactant exhaust chamber couplable to a fuel flow path from the fuel cell stack.

15. The product water pumping system of claim 14, further comprising:
a flexible fluid-impermeable diaphragm that provides a fluid seal between a portion of the product water pumping chamber having the inlet, and a portion of the product water pumping chamber having the drain and the outlet, such that a displacement of the diaphragm by a flow of purge discharge into the product water pumping chamber pumps product water in the product water pumping chamber through the outlet.

16. An electric power generation system, comprising:
a fuel cell stack comprising at least one solid polymer fuel cell;
reactant flow paths to and from the stack; and,
a product water pumping system comprising a product water collector for collecting product water separated from a reactant exhaust stream from the stack, a pump fluid inlet on the collector and fluidly coupled to a reactant flow path, and a product water outlet on the collector, wherein collected product water is pumped out of the collector by a flow of reactant into the collector via the pump fluid inlet.

17. The electric power generation system of claim 16 wherein the product water collector includes a product water pumping chamber for collecting the product water.

18. The electric power generation system of claim 17, further comprising:
a drain formed in the product water pumping chamber for receiving the product water.

19. The electric power generation system of claim 18, further comprising:
a one-way valve formed in the product water pumping chamber and positioned for controlling the flow of product water through the drain into the product water pumping chamber.

20. The electric power generation system of claim 19 wherein the pump fluid inlet fluidly couples the product water pumping chamber to a fuel flow path associated with the stack.

21. The electric power generation system of claim 20 wherein the collector includes a reactant exhaust chamber for separating product water from a reactant exhaust stream flowing therethrough.

22. The electric power generation system of claim 21, further comprising:
an inlet formed in the reactant exhaust chamber coupled to a reactant flow path from the stack for flowing a reactant into the reactant exhaust chamber, and
an outlet formed in the reactant exhaust chamber for discharging the reactant from the reactant exhaust chamber, and wherein the reactant exhaust chamber is fluidly coupled to the drain such that product water separated from the reactant is discharged from the reactant exhaust chamber through the drain and into the product water pumping chamber.

23. The electric power generation system of claim 22 wherein the reactant exhaust chamber inlet is connected to an oxidant flow path from the stack.

24. The electric power generation system of claim 23 wherein the reactant exhaust chamber and the product water pumping chamber are combined in a single product water containment tank, the tank including a partition that when the valve is closed, separates the reactant exhaust chamber from the product water pumping chamber.

25. The electric power generation system of claim 24 wherein the drain is formed in the partition.

26. The electric power generation system of claim 25, further comprising:
a pressure equalization port formed in the partition for equalizing the pressure between the reactant exhaust chamber and the product water pumping chamber.

27. The electric power generation system of claim 23 wherein the reactant exhaust chamber is also coupled to a fuel flow path from the stack.

28. The electric power generation system of claim 27, further comprising:
a purge valve in the fuel flow path, the purge valve being operable to selectively direct a purge discharge from the stack to at least one of the reactant exhaust chamber and the product water pumping chamber.

29. The electric power generation system of claim 28, further comprising:
a flexible fluid-impermeable diaphragm that provides a fluid seal between a portion of the product water pumping chamber having the pump fluid inlet, and a portion of the product water pumping chamber having the drain and the product water outlet, such that a displacement of the diaphragm by a flow of purge discharge into the product water pumping chamber pumps product water in the product water pumping chamber through the product water outlet.

30. The electric power generation system of claim 16 wherein the reactant flow fluidly connected to the pump fluid inlet is from the stack.

31. A product water pumping system, comprising
a product water collector for collecting product water separated from a reactant exhaust stream from a fuel cell stack in an electric power generation system,
a pump fluid inlet on the collector, fluidly coupled to a reactant flow path associated with the stack, and
a product water outlet on the collector,
wherein product water in the collector is pumped out of the product water outlet by a flow of reactant into the collector via the pump fluid inlet.

32. The product water pumping system of claim 31 wherein the reactant flow path fluidly coupled to the pump fluid inlet is from the stack.

33. The product water pumping system of claim 31 wherein the product water collector includes a product water pumping chamber for collecting the product water.

34. The product water pumping system of claim 33, further comprising:
a drain formed in the product water pumping chamber for receiving the product water.

35. The product water pumping system of claim 34, further comprising:
a one-way valve in the drain, for controlling the flow of product water into the product water pumping chamber.

36. The product water pumping system of claim 35 wherein the pump fluid inlet is coupled to a fuel flow path from the stack.

37. The product water pumping system of claim 36 wherein the collector includes a reactant exhaust chamber for the separation of water from an oxidant exhaust stream flowing therethrough.

38. The product water pumping system of claim 37 wherein the reactant exhaust chamber is coupled to an oxidant flow path from the stack.

39. The product water pumping system of claim 38 wherein the reactant exhaust chamber and the product water pumping chamber are combined in a single product water containment tank, the tank comprising a partition that, when the valve is closed, separates the reactant exhaust chamber from the product water pumping chamber.

40. The product water pumping system of claim 39 wherein the drain is formed in the partition.

41. The product water pumping system of claim 40, further comprising:
a pressure equalization port formed in the partition for equalizing the pressure between the reactant exhaust chamber and the product water pumping chamber.

42. The product water pumping system of claim 37, further comprising:
a flexible fluid-impermeable diaphragm that provides a fluid seal between a portion of the product water pumping chamber having the pump fluid inlet, and a portion of the product water pumping chamber having the drain and the product water outlet, such that a displacement of the diaphragm by a flow of a purge discharge into the product water pumping chamber via the pump fluid inlet pumps product water in the product water pumping chamber through the product water outlet.

43. A method of pumping product water out of a fuel cell system, comprising,
separating product water from an oxidant exhaust stream from a fuel cell stack of the fuel cell system;
collecting the separated product water;
discharging the oxidant exhaust stream from the fuel cell system; and,
using a reactant stream to pump the collected product water out of the fuel cell system.

44. The method of claim 43 wherein the reactant stream used to pump product water is a fuel exhaust stream from the stack.

45. The method of claim 44 wherein the fuel exhaust stream is discharged from the fuel cell system along with the separated product water.

46. A pump for a fuel cell system, comprising:
a reactant exhaust chamber having a reactant exhaust inlet couplable to receive a reactant flow from a fuel cell stack of the fuel cell system, a water collecting area, and a reactant exhaust outlet for discharging the reactant from the reactant exhaust chamber;
a product water pumping chamber coupled to the reactant chamber by at least one drain and having a pump fluid inlet couplable to receive a pump fluid from the fuel cell stack and a product water outlet for discharging product water from the product water pumping chamber under pressure of the pump fluid received in the product water pumping chamber; and
a valve positioned to control a flow through the drain between the reactant exhaust chamber and the product water pumping chamber.

47. The pump of claim 46 wherein the reactant exhaust chamber and the product water pumping chamber are formed by a containment vessel and a partition portioning an interior of the containment vessel.

48. The pump of claim 46 wherein the reactant exhaust chamber and the product water pumping chamber are formed by a containment vessel and a partition portioning an interior of the containment vessel, the at least one drain extending through the partition.

49. The pump of claim 46, further comprising:
a diaphragm sealing extending between the pump fluid inlet and both the drain and the product water outlet in the product water pumping chamber.

50. The pump of claim 46 wherein the pump water inlet is coupled to a fuel stream outlet of the fuel cell stack.

51. The pump of claim 46 wherein the pump water inlet is coupled to a purge vent of the fuel cell stack.

52. A pump for a fuel cell system, comprising:
means for collecting water out of a reactant flow from a fuel cell stack; and
fluid driven means for pumping the collected water, the fluid driven pumping means fluidly coupled the fuel cell stack to receive a fluid flow under pressure.

53. The pump of claim 52 wherein the fluid driven means comprises:
a product water pump chamber having a pump fluid inlet,
a product water outlet; and
a valve between the water pump chamber and the water collecting means.

54. A method of pumping product water out of a fuel cell system, comprising,
collecting the product water from a reactant stream in a chamber;
supplying a fluid flow from the fuel cell stack to increase a pressure in the chamber; and
discharging collected product water from the chamber through an product water outlet under the increased pressure.

55. The method of claim 54, further comprising:
separating the product water from an oxidant exhaust stream.

56. The method of claim 54, further comprising:
coupling an fuel exhaust outlet of the fuel cell stack to the chamber, wherein the fluid flow comprises a fuel exhaust stream.

57. The method of claim 54, further comprising:
coupling a purge vent of the fuel cell stack to the chamber wherein the fluid flow comprises a purge from the purge vent.
